(19) United States
(12) Patent Application Publication
(10) Pub. No.: US 2013/0317666 A1
(43) Pub. Date: Nov. 28, 2013

(54) VEHICLE INFORMATION PROVIDING APPARATUS

(71) Applicant: Hiroaki SEKIYAMA, Tokyo (JP)

(72) Inventor: Hiroaki SEKIYAMA, Tokyo (JP)

(73) Assignee: TOYOTA JIDOSHA KABUSHIKI KAISHA, Toyota-shi (JP)

(21) Appl. No.: 13/959,338

(22) Filed: Aug. 5, 2013

Related U.S. Application Data
(63) Continuation of application No. PCT/JP2011/061664, filed on May 20, 2011.

(51) Int. Cl. G06F 17/00

(52) U.S. Cl. CPC G06F 17/00
USPC 701/1

(57) ABSTRACT

An information management center 200 receives vehicle information transmitted from a vehicle 100 and acquires message information on the basis of the received vehicle information. Also, the information management center 200 acquires maintenance information required for the vehicle 100 and campaign information for a user which are transmitted from a dealer 400. The information management center 200 supplies the acquired message information, maintenance information, and campaign information to a service providing center 600. Via a social networking service (SNS), the service providing center 600 provides the message information, maintenance information, and campaign information, which are supplied from the information management center 200, to the user who accesses the service providing center 600 through use of a portable information terminal 300. Also, the service providing center 600 provides the message information and the campaign information to other social networking services (SNSs) as needed.

### TECHNICAL FIELD

The present invention relates to a vehicle information providing apparatus which provides various pieces of information on the basis of information from a vehicle.

### BACKGROUND ART

Conventionally, there have been known a remote vehicle management method, a remote vehicle management system, a server for remote vehicle management, and programs therefor as disclosed in, for example, Patent Document 1 listed below. The conventional remote vehicle management system is composed of a vehicle including an onboard unit, a server, a cellular phone, etc. The onboard unit has a function of detecting the current position of the vehicle through use of a GPS system: a function of acquiring vehicle information representing the open/closed states of doors, the state of the engine, the voltage of the battery, movement of the vehicle during parking, etc.; and a function of transmitting the current position information and the vehicle information to the server through a communication network. By virtue of this, the user can obtain, via a cellular phone, information representing the current position of the vehicle, information representing the consumption of energy of the battery, and information representing the door locked/unlocked state as desired.

In addition, conventionally, there have been known a charge monitoring apparatus, an electric vehicle, and a server as disclosed in, for example, Patent Document 2 listed below. In the conventional charge monitoring apparatus, electric vehicle, and server, through processing performed on the electric vehicle side, a condition for transmitting an acquired charge state to an external server is set on the basis of a user's instruction, and the charge state is transmitted to the external server when the set condition is satisfied.

### PRIOR ART DOCUMENT

### Patent Document

Patent Document 1: Japanese Patent Application Laid-Open (kokai) No. 2004-334862
Patent Document 2: Japanese Patent Application Laid-Open (kokai) No. 2010-252449

### SUMMARY OF THE INVENTION

Incidentally, the system disclosed in Patent Document 1 and the apparatus disclosed in Patent Document 2 can provide information useful to a user, for example. However, messages represented by the transmitted information may become businesslike and stereotypical.

Accordingly, if the user uses the system disclosed in Patent Document 1 or the apparatus disclosed in Patent Document 2 for a long period of time, the user becomes indifferent to the information transmitted from these system and apparatus. As a result, the user may become less interested in the transmitted information. However, since information transmitted from the vehicle side is important, it is desired that the user always acquire it with interest.

The present invention has been accomplished in order to solve the above-described problem, and its object is to provide a vehicle information providing apparatus for providing various pieces of information that can easily attract the attention of the user, on the basis of the information transmitted from a vehicle.

In order to achieve the above-described object, the present invention provides a vehicle information providing apparatus comprising vehicle information acquisition means for acquiring information which is supplied from a vehicle and which represents a state of the vehicle; and information providing means for providing various pieces of information to a user of the vehicle. The vehicle information providing apparatus further comprises user information acquisition means for acquiring user information which is provided in advance so as to receive various pieces of information from the information providing means by identifying the user of the vehicle; message information generation/acquisition means for generating and acquiring message information, which represents the state of the vehicle and which is provided to at least the user of the vehicle, on the basis of the information which is acquired by the vehicle information acquisition means and which represents the state of the vehicle; and message information supply means for supplying to the information providing means the message information, which is generated and acquired by the message information generation/acquisition means, on the basis of the user information acquired by the user information acquisition means. When the user requests presentation of the message information by use of the user information, the information providing means provides to the user the message information supplied from the message information supply means.

By virtue of this feature, the message information generation/acquisition means can generate and acquire the message information which represents the state of the vehicle on the basis of the information which is acquired from the vehicle and which represents the state of the vehicle, and the information providing means can provide to the user the message information generated by the message information generation/acquisition means as mentioned above. By virtue of this, the message information generation/acquisition means can generate and acquire message information expressed in various ways, and the information providing means can provide to the user the message information expressed in various ways. Therefore, the user can always have interest in the message represented by the provided message information. Namely, since the user can receive messages expressed in various ways, the user can acquire important information transmitted from the vehicle side always with interest as compared with the case where the user receives businesslike and stereotypical messages.

Preferably, the vehicle is personified, and the message information generation/acquisition means generates and acquires the message information, as a message from the personified vehicle, on the basis of the information which is acquired by the vehicle information acquisition means and which represents the state of the vehicle.

By virtue of this feature, the message information generation/acquisition means can generate and acquire message information as a message from the personified vehicle. Accordingly, the user can receive a message as if it is spoken by the personified vehicle, whereby the user can acquire important information transmitted from the vehicle side with more familiarity (in other words, with more interest) as compared with the case where the user receives businesslike and stereotypical messages.

Preferably, the information providing means provides through, for example, a social networking service the message information supplied from the message information supply means.

By virtue of this feature, not only the user but also third parties can easily join the circle of communication associated with the message information provided by the information providing means. Accordingly, the circle of communication can be expanded easily.

Preferably, the message information generation/acquisition means classifies a plurality of pieces of the generated and acquired message information into those which require confidentiality and which should be provided only to the user and those which do not require confidentiality and which can also be provided to third parties other than the user, the message information supply means supplies the plurality of pieces of the message information to the information providing means in accordance with the classification determined by the message information generation/acquisition means, and the information providing means provides the plurality of pieces of the message information, which are supplied from the message information supply means, in accordance with the classification determined by the message information generation/acquisition means. In this case, preferably, the information providing means provides to an external information providing apparatus a piece of the message information which is classified by the message information generation/acquisition means as that which does not require confidentiality and which can also be provided to third parties other than the user, the piece of the message information being among the plurality of pieces of the message information supplied from the message information supply means. In this case, preferably, the external information providing apparatus provides through, for example, a social networking service the message information provided by the information providing means.

By virtue of these features, the piece of the message information provided to third parties by the information providing means can be distinguished from other pieces of the message information. Therefore, not only the user but also third parties can have interest in the messages provided for third parties. As a result, the user can perform communication using the messages provided for third parties, whereby the circle of communication can be expanded.

Preferably, the user supplies the user information to the information providing means by use of a portable information terminal apparatus owned by him/her, and acquires the message information from the information providing means by use of the portable information terminal apparatus.

By virtue of this feature, the user can acquire message information quite easily by use of a portable information terminal owned by him/her; e.g., a cellular phone such as a smartphone. Accordingly, the user can check messages quite easily, whereby the user can acquire important information transmitted from the vehicle side with more familiarity; in other words, with more interest.

Another feature of the present invention resides in that the vehicle information providing apparatus includes vehicle stoppage state determination means for determining whether or not the vehicle is in a stopped state, the message information supply means supplies the message information to the information providing means when the vehicle stoppage state determination means determines that the vehicle is in the stopped state, and the message information supply means does not supply the message information to the information providing means when the vehicle stoppage state determination means determines that the vehicle is not in the stopped state.

Preferably, the vehicle stoppage state determination means determines whether or not the vehicle is in the stopped state in accordance with, for example, the operation state of an ignition switch of the vehicle. More specifically, preferably, the vehicle stoppage state determination means determines that the vehicle is in the stopped state when, for example, the operation position of the ignition switch of the vehicle is changed from an “accessory-on” operation position to an “accessory-off” operation position.

With these features, the vehicle stoppage state determination means can determine that the vehicle is in the stopped state (parked) in accordance with the operation state of the ignition switch of the vehicle (more specifically, when the operation position of the ignition switch of the vehicle is changed from the “accessory-on” operation position to the “accessory-off” operation position). Therefore, only when the vehicle is in the stopped state, the message information supply means provides the message information to the information providing means.

Notably, when the vehicle is traveling; in other words, when the operation position of the ignition switch of the vehicle is in the “accessory-on” operation position, the user who is riding on the vehicle can directly acquire from the vehicle the information representing the state of the vehicle. In this case, if the user acquires message information, this message information may be the same as that which the user can directly acquire from the vehicle. When the user acquires a plurality of identical pieces of information redundantly, he or she may feel annoyed. As a result, the user may become indifferent to (less interested in) the information transmitted from the vehicle side.

In contrast, when the vehicle is travelling, the message information supply means does not supply message information. This operation can prevent the information providing means from providing the same information as that which the user can acquire directly. Accordingly, the user of the vehicle does not become indifferent to the information transmitted from the vehicle side, which would otherwise occur when the user acquires the information redundantly. Therefore, the user of the vehicle can acquire important information transmitted from the vehicle side always with interest.

### BRIEF DESCRIPTION OF THE DRAWINGS

FIG. 1 is a schematic diagram of an information communication system for a vehicle including a vehicle information providing apparatus according to respective embodiments of the present invention.

FIG. 2 is a block diagram schematically showing the configuration of a vehicle shown in FIG. 1.

FIG. 3 is a block diagram schematically showing the configuration of an information management center shown in FIG. 1.

FIG. 4 is a block diagram schematically showing the configuration of a portable information terminal shown in FIG. 1.

FIG. 5 is a block diagram schematically showing a dealer shown in FIG. 1.

FIG. 6 is a block diagram schematically showing a service providing center shown in FIG. 1.

FIG. 7 is a flowchart which is related to a first embodiment of the present invention and which is used for describing the flow of information among the vehicle, information management center, dealer, service providing center, and portable information terminal shown in FIG. 1.

FIG. 8 is a flowchart which is related to a second embodiment of the present invention and which is used for describing the flow of information among the vehicle, information management center, dealer, service providing center, and portable information terminal shown in FIG. 1.

### BEST MODE FOR CARRYING OUT THE INVENTION

### a. First Embodiment

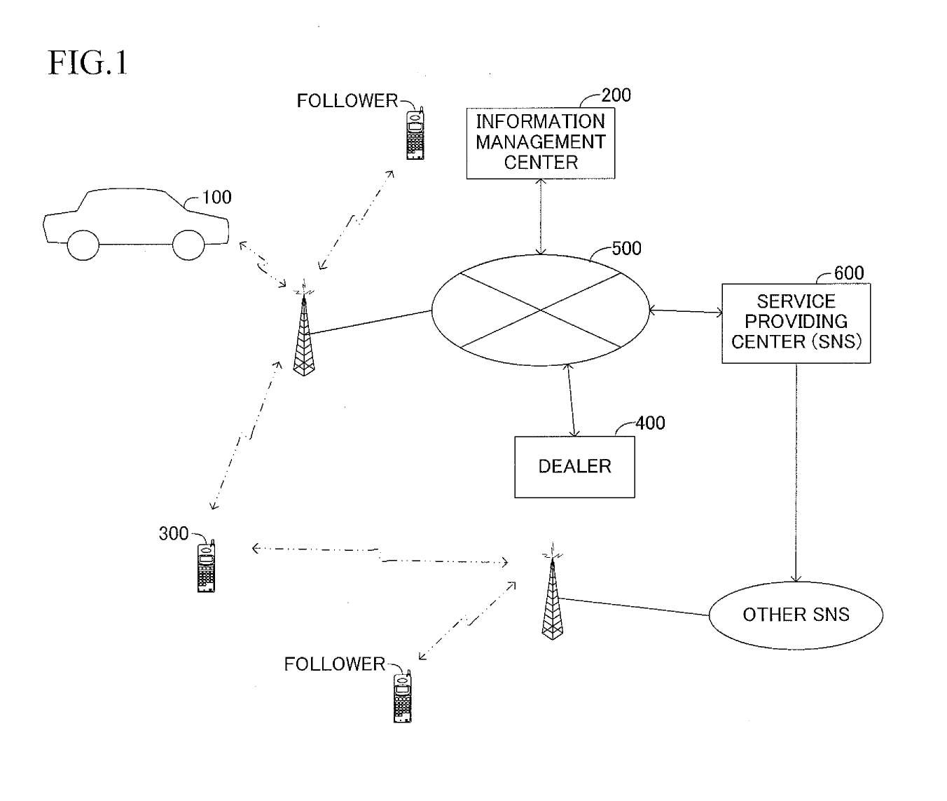

Hereinafter, a vehicle information providing apparatus according to a first embodiment of the present invention will be described with reference to the drawings. FIG. 1 is a schematic block diagram schematically showing an information communication system for a vehicle which has a vehicle information providing apparatus according to the present invention and which is common to all embodiments.

First, the information communication system for a vehicle will be described. In the information communication system for a vehicle, a vehicle 100, an information management center 200, a portable information terminal 300 owned by a user of the vehicle 100, a dealer 400 who sold the vehicle 100 and performs maintenance, etc. are organically connected via a secure network 500 (e.g., the Internet, a leased network, etc.) such that various services and various pieces of information can be provided to the user. In addition, this information communication system for a vehicle includes a service providing center 600 which is connected to the network 500 in order to provide a social networking service (SNS). The service providing center 600 provides contractors (so-called followers, etc.) who have concluded a service provision contract, including the user, with message information relating to the vehicle 100 received from the information management center 200. In addition, the service providing center 600 can also collaborate with other social networking services (SNSs).

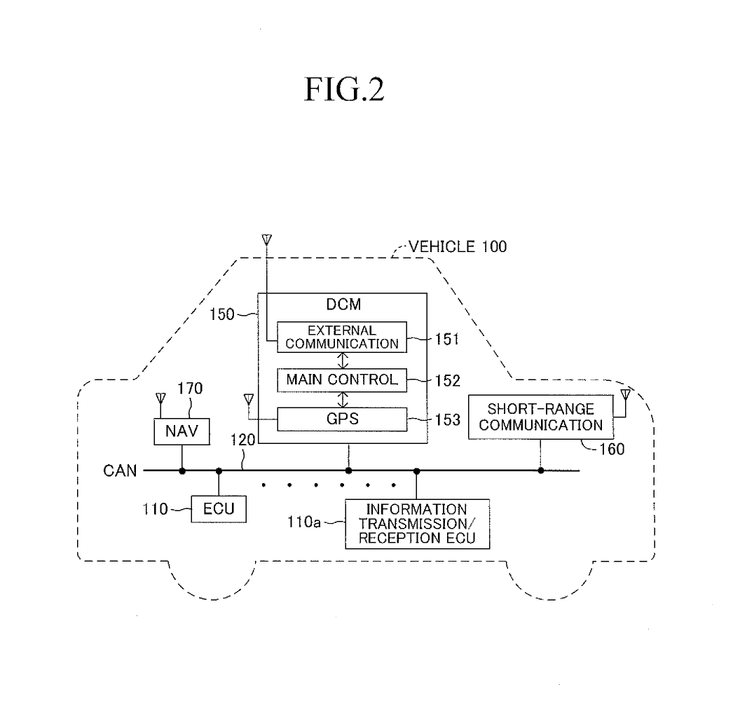

As shown in FIG. 2, the vehicle 100 is provided with a plurality of electronic control units 110 (hereinafter referred to as vehicle ECUs 110) for controlling the state of the vehicle. The vehicle ECUs 110 are connected to a CAN communication line 120 of a CAN (Controller Area Network) communication system such that they can exchange (input/output) various signals with one another through the CAN communication line 120. Each vehicle ECU 110 is mainly composed of a microcomputer including a CPU, a ROM, a RAM, etc. Each vehicle ECU 110 has a memory, an input/output interface, and a drive circuit for driving various actuators using signals received from sensors. In addition, an information transmission/reception ECU 110a is provided, as one of the plurality of vehicle ECUs 110 connected to the CAN communication line 120. The information transmission/reception ECU 110a collects various pieces of information representing the state of the vehicle 100 and output from the remaining vehicle ECUs 100 (hereinafter also referred to as vehicle information) and controls transmission of the vehicle information to the center 200.

In addition, a data communication module 150 (hereinafter referred to as a DCM 150) for communicating with the center 200 via the network 500 is connected to the CAN communication line 120. The DCM 150 includes an external communication control section 151 which sends and receives data to/from a server 210 (described later) of the center 200 via the network 500; a main control section 152 which sends and receives data to/from the vehicle ECUs 110 (including the information transmission/reception ECU 110a) via the CAN communication line 120 so as to acquire control information (including vehicle information) and output instructions to the vehicle ECUs 110; and a GPS unit 153 which detects the coordinates of the current position of the vehicle on the basis of the radio waves from GPS satellites. The DCM 150 mainly composed of a microcomputer includes a memory, a communication circuit, an input/output interface, etc.

In addition, a short-range communication control apparatus 160 is connected to the CAN communication line 120 as a communication interface for performing short-range communication with the portable information terminal 300. In the present embodiment, this short-range communication control apparatus 160 employs Bluetooth (registered trademark) as a communication technology. Needless to say, the short-range communication control apparatus 160 may use other short-range radio communication technologies such as Wi-Fi (registered trademark).

In addition, a navigation apparatus 170 for guiding the vehicle 100 to its destination is connected to the CAN communication line 120. The navigation apparatus 170 includes a vehicle position detection unit which detects the position and heading direction of the vehicle 100; a memory which stores various types of data such as map data; a microcomputer which executes an application for guiding the vehicle to its destination; a human interface which includes a touch-panel-type liquid-crystal display and a speaker; and so on (not shown).

Preferably, the vehicle 100 applied to the information communication system is an electric vehicle (EV) which includes a traction motor driven by electric power of a battery, or a plug-in hybrid vehicle (PHV) which includes a traction motor, an internal combustion engine, and a battery which can be charged by a charger. However, the vehicle 100 may be a conventional vehicle which does not have a traction motor and which travels through use of power of the internal combustion engine. The vehicle 100 may be of any drive type.

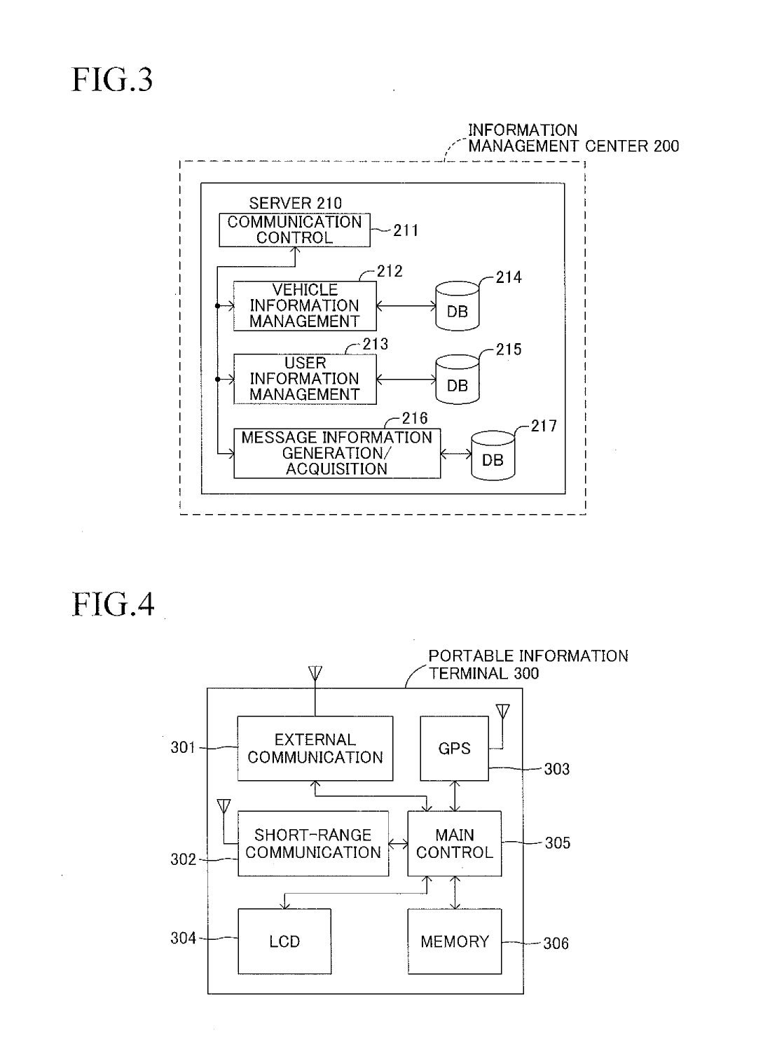

As shown in FIG. 3, the information management center 200 is a facility for acquiring various pieces of information from the information transmission/reception ECU 110a of the vehicle 100 and a server 410 of the dealer 400 and for providing the user of the vehicle 100 with various pieces of service information. The information management center 200 includes a server 210 which is mainly composed of a microcomputer. The server 210 includes a communication control section 211 which is connected to the network 500 so as to control communications; a vehicle information management server 212 which manages various pieces of information (including vehicle information) relating to the vehicle 100; a user information management server 213 which manages information relating to the vehicle user; a vehicle information storage section 214 which stores a database of various pieces of information (including vehicle information) relating to the vehicle 100; and a user information storage section 215 which stores a database of user information (e.g., user account information which is used to access the information management center 200 and the service providing center 600).

In addition, the server 210 of the information management center 200 includes a message information generation/acquisition server 216 and a message information storage section 217 which stores a database of various pieces of message information. On the basis of the vehicle information, etc. of the vehicle 100 supplied from the vehicle information management server 212, the message information generation/acquisition server 216 acquires message information relating to the vehicle information, etc. from the message information storage section 217.

Notably, the server 210 retains relation information for establishing a relation between ID information for identifying the vehicle 100 (information representing the registration number or chassis number of the vehicle) and ID information for identifying the user (the name of the user, the phone number of the information terminal 300, the mail address, etc.). By means of specifying one of the two pieces of ID information, information which is specified by the other piece of ID information can be extracted.

As shown in FIG. 1 and FIG. 4, the portable information terminal 300 owned by the user includes an external communication control section 301 which is a communication interface used for connection to the secure network 500 and social networking services (SNSs) other than the social networking service (SNS) provided by the service providing center 600; a short-range communication control section 302 which is a communication interface used to perform short-range radio communication using Bluetooth (registered trademark); a GPS unit 303 which detects the coordinates of the current position of the portable information terminal 300 using the radio waves from GPS satellites; a touch-panel liquid crystal display 304 which serves as a display panel and an operating panel; a main control section 305 which is mainly composed of a microcomputer and is adapted to execute communication control and various application programs; and a nonvolatile memory 306 which stores various types of data such as application programs. Notably, for example, a cellular phone such as a smartphone, a tablet terminal having an external communication function, or a like device can be employed as the portable information terminal 300.

The user of the vehicle 100 and the portable information terminal 300 can perform a process for pairing the vehicle 100 with the portable information terminal 300 in advance. By means of paring the vehicle 100 with the portable information terminal 300 in advance, information can be exchanged seamlessly. For example, vehicle information, etc. that the information transmission/reception ECU 110a of the vehicle 100 has collected from other vehicle ECUs 110 can be transmitted to the information management center 200 using the portable information terminal 300 in place of the DCM 150. Also, various pieces of information (e.g., music, video images, text data, etc.) that the portable information terminal 300 has obtained in advance or is obtaining in real time via the Internet can be output to the touch-panel-type liquid-crystal display and the speaker of the navigation apparatus 170 via the CAN communication line 120. Notably, since the pairing process for Bluetooth (registered trademark) devices is not related directly to the present invention, it will be described below only briefly.

In general, when a Bluetooth (registered trademark) device is used for the first time, a process (operation) called paring is required for identifying a counterpart device. In this case, the user of the vehicle 100 operates, for example, the short-range communication control apparatus 160 of the vehicle 100 to bring it into a searchable state in which it can search for the portable information terminal 300, i.e., the counterpart device. On the other hand, the user of the vehicle 100 operates the portable information terminal 300 so as to bring its short-range communication control section 302 into the searchable state via its main control section 305. Before the short-range communication control apparatus 160 and the short-range communication control section 302 are set into the searchable state, their settings for authentication/encryption are rendered the same.

By means of bringing the respective Bluetooth (registered trade mark) devices in the searchable state as mentioned above, Bluetooth (registered trademark) devices existing nearby (i.e., the vehicle 100 and the portable information terminal 300) are displayed on, for example, a display of the navigation apparatus 170 and the touch-panel-type liquid-crystal display 304 of the portable information terminal 300. The user designates the vehicle 100 as a counterpart device of the portable information terminal 300, and designates the portable information terminal 300 as a counterpart device of the vehicle 100. After selecting the vehicle 100 and the portable information terminal 300 as the counterpart devices, the user enters the same passkey (authentication key (PIN)) into the short-range communication control apparatus 160 and the short-range communication control section 302. The short-range communication control apparatus 160 and the short-range communication control section 302 exchange the entered passkey with each other, whereby the pairing process is completed.

Once the paring process for taking advantage of Bluetooth (registered trademark) communications is completed between the vehicle 100 and the portable information terminal 300 as mentioned above, Bluetooth (registered trademark) connection is automatically established when the driver carrying the portable information terminal 300 gets into the vehicle 100 and sets the ignition switch (not shown) to the “accessory-on” operation position. Notably, when the connection (pairing) is established automatically, a lamp provided, for example, in the meter cluster lights up so as to inform the user of the establishment of the connection.

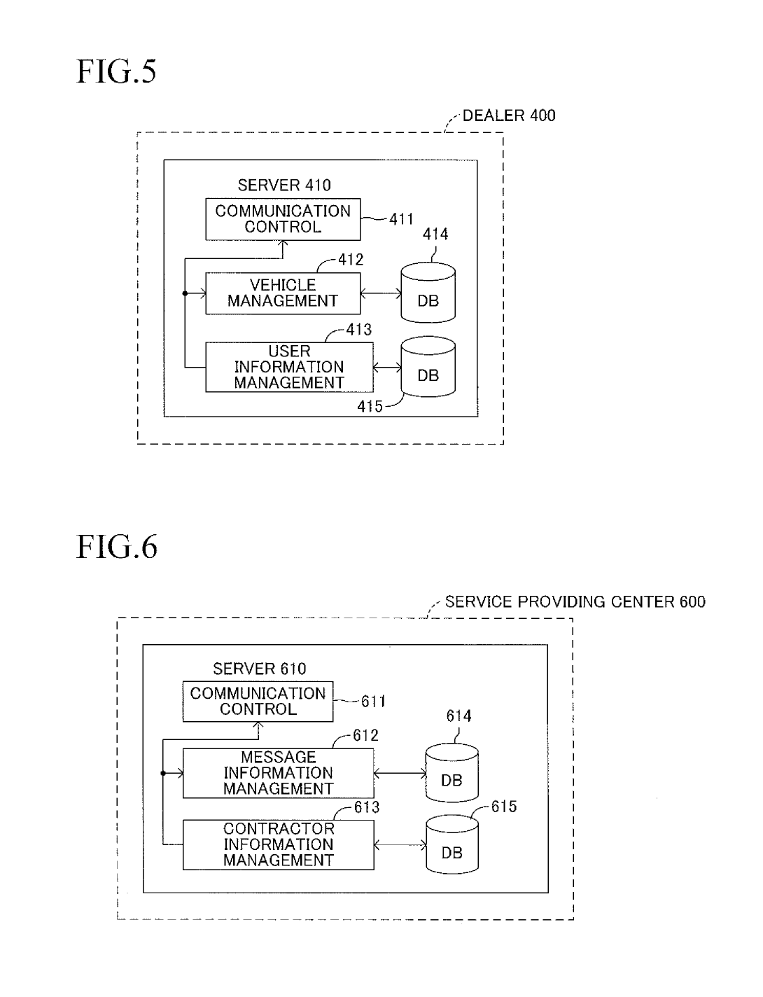

As shown in FIG. 5, the dealer 400 is a facility that acquires event information (e.g., information representing the states of onboard devices, etc.) of a sold vehicle 100 from the vehicle 100 via the information management center 200, and provides the user with information about whether or not the vehicle 100 requires maintenance, campaigns, etc. The dealer 400 is provided with a server 410 mainly composed of a microcomputer. The server 410 includes a communication control section 411 which is connected to the network 500 so as to control communications; a vehicle management server 412 which manages the event information from the vehicle 100; a user information management server 413 which manages the user information of the vehicle 100; an event information storage section 414 which stores a database of campaign information and maintenance information corresponding to the event information of the vehicle 100; and a user information storage section 415 which stores a database of user information (e.g., the user name, the ID information for identifying the vehicle 100, the ID information for identifying the user, the user account information used to access the information management center 200 (and the service providing center 600), etc.).

As shown in FIG. 6, the service providing center 600 is a facility that discloses and provides the message information supplied from the information management center 200 to, for example, the contractors who have concluded a social networking service provision contract, through the social networking service. The service providing center 600 is provided with a server 610 mainly composed of a microcomputer. The server 610 includes a communication control section 611 which is connected to the network 500 and other centers (servers) providing other social networking services (SNSs) as shown in FIG. 1 and which controls communications; a message information management server 612 which manages provision of the message information supplied from the information management center 200; a contractor information management server 613 which manages information about the service contractors including the user of the vehicle 100; a message information storage section 614 which stores a database of the supplied message information; and a contractor information storage section 615 which stores a database of contractor information (e.g., the ID information for identifying the user, the account information used by the contractor in order to access the service providing center 600, etc.).

Next, there will be described the vehicle information providing apparatus which is applied to the vehicle information communication system configured as mentioned above. In this first embodiment, the vehicle 100 transmits vehicle information and event information to the information management center 200 via the network 500, and the information management center 200 acquires the message information relating to the received vehicle information and transmits it to the service providing center 600. Also, in this first embodiment, the information management center 200 transmits to the dealer 400 the event information acquired from the vehicle 100, and transmits to the service providing center 600 the maintenance information, campaign information, etc. which are based on the event information and transmitted from the dealer 400. In addition, in this first embodiment, the service providing center 600 discloses and provides the message information, maintenance information, etc acquired from the information management center 200 to the service contractors via the network 500 and the social networking services (SNSs).

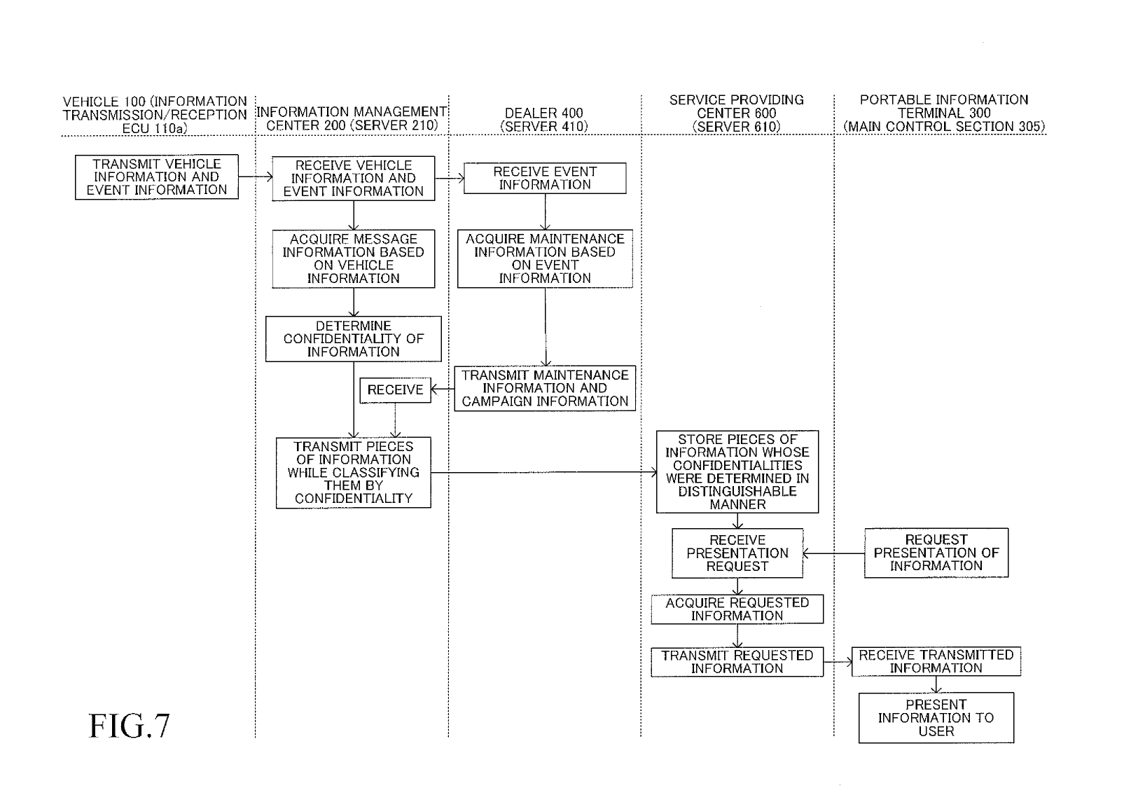

Accordingly, the vehicle information providing apparatus according to the present invention is realized through cooperation mainly between the information management center 200 and the service providing center 600. Hereinafter, operation of the information providing apparatus according to the first embodiment will be described in detail with reference to FIG. 7.

### <Vehicle 100>

First, in the vehicle 100, as shown in FIG. 7, the information transmission/reception ECU 110a collects vehicle information from the remaining vehicle ECUs 110, and transmits the collected vehicle information via the DCM 150 to the information management center 200 connected to the network 500. Notably, examples of the vehicle information collected and transmitted by the information transmission/reception ECU 110a include diagnostic information of the vehicle 100; current position information of the vehicle 100; and eco-related information such as a score of eco-driving or an EV running distance over which the vehicle 100 traveled in the EV mode (in the case where the vehicle 100 is of an PHV type). In the case where vehicle 100 is of an EV or PHV type, the vehicle information may be information representing the start and stop of battery charging, information representing the SOC (Stage of Charge) of the battery, or information representing the state of air conditioning performed through remote operation.

In addition, the information transmission/reception ECU 110a collects event information from the remaining vehicle ECUs 110, and transmits the collected event information via the DCM 150 to the information management center 200 connected to the network 500. Notably, examples of the event information that the information transmission/reception ECU 110a collects from the remaining vehicle ECUs 110 and transmits to the information management center 200 include information on the basis of which necessity of maintenance is determined, such as information representing a drop in engine oil pressure or a drop in tire air pressure. Notably, when transmitting vehicle information and event information as mentioned above, the information transmission/reception ECU 110a adds ID information for identifying the vehicle 100 (hereinafter referred to as vehicle identifying ID information) to the vehicle information and the event information.

### <Information Management Center 200>

In the information management center 200, as shown in FIG. 7, the server 210 receives via the network 500 and the communication control section 211 the vehicle information and the event information transmitted by the information transmission/reception ECU 110a of the vehicle 100 along with the vehicle identifying ID information. Subsequently, in the server 210, the vehicle information management server 212 relates the received event information and vehicle identifying ID information to each other and transmits them to the dealer 400 connected to the network 500.

In addition, in the server 210, the vehicle information management server 212 stores the received vehicle information at a predetermined storage position in the vehicle information storage section 214 with the vehicle information related to the vehicle identifying ID information such that it can be searched for later. At this time, in the server 210, the ID information for identifying the user (hereinafter referred to as user identifying ID information) is acquired by use of the received vehicle identifying ID information. Subsequently, in the server 210, the user information management server 213 searches the user information storage section 215 by use of the user identifying ID information acquired as mentioned above, to thereby acquire the account information given to the user who is identified by the user identifying ID information.

After the vehicle information management server 212 has stored the vehicle information of the vehicle 100 at the predetermined storage position in the vehicle information storage section 214 as mentioned above, in the server 210, the message information generation/acquisition server 216 generates and acquires the message information relating to the vehicle information of the vehicle 100 which has been stored in the vehicle information storage section 214. The message information generation/acquisition server 216 generates and acquires the message information on the basis of the stored vehicle information while referring to the message information storage section 217. For example, the message information generation/acquisition server 216 determines a message (fixed sentence) having an image corresponding to the state of the vehicle 100 on the basis of the vehicle information of the vehicle 100. Subsequently, the message information generation/acquisition server 216 disassembles the determined message into phrases. The message information generation/acquisition server 216 appropriately selects text data suitable for the disassembled phrases from the message information storage section 217 on the basis of the vehicle information of the vehicle 100, and combines the selected text data of the phrases to thereby generate a piece of message information representing one message. Thus, there can be acquired message information that can attract the attention of the user through personification of the vehicle 100 (described later), instead of a businesslike and stereotypical message.

Subsequently, as shown in FIG. 7, the message information generation/acquisition server 216 determines whether or not the message information generated and acquired on the basis of the vehicle information of the vehicle 100 requires confidentiality. That is, the message information generation/acquisition server 216 determines whether or not the message information acquired on the basis of the vehicle information of the vehicle 100 is the one that requires confidentiality (that is, this message information should not be, or need not be, disclosed to third parties (contractors) other than the user) or the one that does not require confidentiality (that is, this information may be disclosed to third parties (contractors) other than the user). On the basis of the above-mentioned determination, the message information generation/acquisition server 216 adds to respective pieces of message information confidentiality identification information representing whether or not confidentiality is required.

Hereunder, message information that the message information generation/acquisition server 216 generates/acquires by use of the message information storage section 217 will be exemplarily described with consideration given to whether or not confidentiality is required.

First, examples of the message information that requires confidentiality include diagnostic information and information relating to the battery installed in an EV or a PHV. Specifically, the message information generation/acquisition server 216 generates and acquires message information representing a message which is to be spoken to the user by the personified vehicle 100 just like a self-talk. For example, the message information generation/acquisition server 216 generates and acquires message information representing a message “I am glad if you charge me soon!” in a situation where it is determined on the basis of the SOC information that battery charging is necessary, and message information representing a message “Something's wrong with me.” in a situation where it is determined on the basis of the diagnostic information that maintenance is necessary.

Meanwhile, examples of the message information that may be disclosed and that does not require confidentiality include message information relating to the information about the approximate position of the travelling vehicle 100 and information relating to eco-information. Specifically, the message information generation/acquisition server 216 generates and acquires message information representing a message that allows a third party (follower) to see the message with interest and motivates him/her to provide a comment to the personified vehicle 100. For example, the message information generation/acquisition server 216 generates and acquires message information representing a message “Passing XXXX (a famous land mark) on my right.” in a situation (image) where the user is driving in a tourist area (instead of a message reporting an exact address), and information representing a message “Passing XXXX (number) green lights in row! Lucky!” in a situation (image) where the user is driving in consideration of echo-driving (instead of a message directly telling that the current fuel/electricity consumption is low by use of a numerical value).

After generating and acquiring message information, determining whether or not this message information requires confidentiality, and adding confidentiality identification information to this message information where needed, as shown in FIG. 7, the message information generation/acquisition server 216 transmits the message information and the confidentiality identification information via the communication control section 211 to the service providing center 600 connected to the network 500 in such a manner that the message information is related to the confidentiality identification information; i.e., in a state in which the message information is classified in terms of necessity of confidentiality. Notably, the message information generation/acquisition server 216 transmits the message information and the confidentiality identification information to the service providing center 600 together with the account information acquired by the user information management server 213 such that it is related to these two pieces of information.

Next, there will be described the case where the message information generation/acquisition server 216 has received maintenance information and/or campaign information from the server 410 of the dealer 400 as mentioned later before transmitting the message information, the confidentiality identification information, and the account information. In such a case, as shown in FIG. 7, the message information generation/acquisition server 216 transmits the maintenance information and/or campaign information via the communication control section 211 to the service providing center 600 connected to the network 500 in such a manner that these pieces of information are also classified in terms of necessity of confidentiality. Specifically, in the information management center 200, the message information generation/acquisition server 216 determines whether or not the maintenance information and/or the campaign information received from the dealer 400 require confidentiality as described below before transmitting them to the service providing center 600. That is, upon receipt of the maintenance information which has been transmitted from the dealer 400 and which has been related to the account information, the message information generation/acquisition server 216 determines that this maintenance information requires confidentiality. On the other hand, upon receipt of campaign information which is not limited to the user of a specific vehicle 100, the message information generation/acquisition server 216 determines that this campaign information does not require confidentiality. Subsequently, on the basis of the result of the above-described determination, the message information generation/acquisition server 216 transmits the maintenance information and campaign information via the communication control section 211 to the service providing center 600 connected to the network 500 in such a manner that these pieces of information are classified in terms of necessity of confidentiality.

### <Dealer 400>

In the dealer 400, as shown in FIG. 7, the vehicle management server 412 constituting the server 410 receives via the network 500 and the communication control section 411 the event information which has been transmitted from the vehicle information management server 212 of the information management center 200 and which has been related to the vehicle identifying ID information. Subsequently, the vehicle information management server 412 stores the received and acquired event information in the event information storage section 414 such that it is related to the vehicle identifying ID information.

Next, as shown in FIG. 7, on the basis the acquired event information, the vehicle management server 412 searches the event information storage section 414 in order to acquire the maintenance information corresponding to this event information (e.g., text information which represents details on maintenance and which prompts the user to make a reservation for taking his/her vehicle 100 to the dealer 400 for maintenance, etc.). On the other hand, the user information management server 413 constituting the server 410 searches the user information storage section 415 by use of the acquired vehicle identifying ID information in order to acquire the account information given to the user who is identified by the vehicle identifying ID information.

Next, the vehicle management server 412 relates the maintenance information acquired from the event information storage section 414 and the account information acquired by the user information management server 413 to each other, and transmits them via the communication control section 411 to the information management center 200 connected to the network 500. Simultaneously, as shown in FIG. 7, the vehicle management server 412 acquires campaign information (e.g., text information representing that engine oil can be changed at low price, etc.) from the event information storage section 414, and transmits it via the communication control section 411 to the information management center 200 connected to the network 500.

### <Service Providing Center 600>

In the service providing center 600, the message information management server 612 constituting the server 610 receives via the communication control section 611 the respective pieces of information which have been transmitted from the message management server 216 of the information management center 200 connected to the network 500. Subsequently, in the case where the confidentiality identification information added to the received message information shows that the received message information is message information which requires confidentiality (namely, message information which should be checked only by the user), the message management server 612 stores the received message information at a predetermined position in the message information storage section 614 (hereafter referred to as a private information storage area) as private message information. At this time, the message management server 612 stores the message information in the private information storage area of the message information storage section 614 while relating it to the acquired user's account information.

Meanwhile, in the case where the confidentiality identification information added to the received message information shows that the received message information is message information which does not require confidentiality (namely, message information which may be disclosed to contractors other than the user), the message management server 612 stores the received message information at a predetermined position in the message information storage section 614 (hereafter referred to as a public information storage area) as open message information. At this time, the message management server 612 stores the message information in the public information storage area of the message information storage section 614 without relating it to the account information.

In addition, upon receipt of maintenance information and account information from the message information generation/acquisition server 216 of the information management center 200, the message information management server 612 determines that this maintenance information requires confidentiality (namely, it is private information that should be checked only by the user), and stores it in the private information storage area of the message information storage section 614 while relating it to the account information. Meanwhile, upon receipt of campaign information from the message information generation/acquisition server 216 of the information management center 200, the message information management server 612 determines that this campaign information does not require confidentiality (i.e., it is open information that should be disclosed to the contractors including the user), and stores it in the public information storage area of the message information storage section 614.

Notably, in the case where message information and maintenance information are stored, for example, if the user identifying ID information has been transmitted from the message information generation/acquisition server 216 of the information management center 200 along with the message information and maintenance information, the contractor information management server 613 constituting the server 610 can search the contractor information storage section 615 by use of the user identifying ID information in order to acquire the account information corresponding to this user identifying ID information. Since the contractor information management server 613 acquires account information as mentioned above, the message management server 612 can acquire the account information and store the message information and maintenance information which require confidentiality in the private information storage area of the message information storage section 614 while relating these two pieces of information to the account information.

Since the message information, maintenance information, and campaign information supplied from the information management center 200 are stored in the private information storage area and the public information storage area of the message information storage section 614 such that private information and open information can be distinguished from each other, the message information management server 612 can appropriately provide the message information, maintenance information, and campaign information to the user through communication with the portable information terminal 300. That is, on the basis of the account information which is related to the message information and maintenance information stored in the private information storage area, the message information management server 612 provides the message information and maintenance information only to the user who owns this account information in the case where the service providing center 600 is accessed using this account information. On the other hand, in the case where the service providing center 600 is accessed using some other account information, the message information management server 612 provides the message information and campaign information stored in the public information storage area to the user who has accessed the service providing center 600. That is, in this case, the message information management server 612 can disclose and provide the message information and campaign information to all users who have accessed the service providing center 600.

Also, the message information management server 612 of the service providing center 600 can provide the message information stored in the public information storage area of the message information storage section 614 to other centers, servers, etc. which provide other social networking services (SNSs). By virtue of this, the message information management server 612 can provide, for example, the message information relating to the eco-related information of an EV or PHV and the campaign information, which is transmitted from the dealer 400, to more followers other than the contractors of the social networking service (SNS) provided by the service providing center 600.

### <Portable Information Terminal 300>

In the portable information terminal 300, the user accesses the service providing center 600 by use of, for example, a predetermined application program started by him/her. That is, in the portable information terminal 300, the main control section 305 starts the predetermined application program in response to a predetermined operation performed by the user, and executes this application program in order to prompt the user to enter his/her account information through use of the touch-panel-type liquid-crystal display 304. Subsequently, through use of the touch-panel-type liquid-crystal display 304, the main control section 305 asks the user to select either the presentation of private message information and maintenance information for the user of the vehicle 100 or the presentation of open message information and campaign information for the third party.

When the user selects the presentation of private message information and maintenance information, the main control section 305 transmits presentation request information for requesting the presentation of private message information and maintenance information along with the entered user's account information via the external communication control section 301 to the service providing center 600 connected to the network 500. On the other hand, when the user selects the presentation of open message information and campaign information, the main control section 305 transmits presentation request information for requesting the presentation of open message information and campaign information along with the entered user's account information via the external communication control section 301 to the service providing center 600 connected to the network 500.

In the case where the user selects the presentation of private message information and maintenance information as mentioned above, the message information management server 612 of the service providing center 600 acquires, in accordance with the presentation request from the portable information terminal 300, the message information and maintenance information which are related to the account information coinciding with the account information received from the portable information terminal 300 among a plurality of pieces of message information and maintenance information stored in the private information storage area of the message information storage section 614. Subsequently, the message information management server 612 of the service providing center 600 transmits the acquired message information and maintenance information to the portable information terminal 300.

On the other hand, in the case where the user selects the presentation of open message information and campaign information, the message information management server 612 of the service providing center 600 acquires, in accordance with the presentation request from the portable information terminal 300, the message information and campaign information stored in the public information storage area of the message information storage section 614. Subsequently, the message information management server 612 of the service providing center 600 transmits the acquired message information to the portable information terminal 300.

Notably, in the present embodiment, the user selects either the presentation of private information or the presentation of open information by use of the portable terminal apparatus (portable information terminal) 300. However, as mentioned above, since the service providing center 600 can acquire the message information and maintenance information which are related to the account information coinciding with the account information received from the portable information terminal 300 among the plurality of pieces of message information and maintenance information stored in the private information storage area of the message information storage section 614, needless to say, the above-described selection by the user may be omitted. In this case, the user only enters the account information without making the above-described selection.

In the portable information terminal 300, as mentioned above, the main control section 305 receives, via the external communication control section 301, the user-requested message information, maintenance information, and campaign information transmitted from the service providing center 600 connected to the network 500. Subsequently, the main control section 305 displays at least one piece of the received message information, maintenance information, and campaign information on the touch-panel-type liquid-crystal display 304, to thereby present the information to the user. In this case, since private message information and maintenance information which require confidentiality are presented only to the user, only the user can check the details thereof. In particular, since the message information presented at this time is a friendly message as mentioned previously, the user can check its details always with interest.

As to the open message information and campaign information which do not require confidentiality, the user can view the message information corresponding to the account that the user follows (pays attention to) just like the case of the well-known social networking services (SNSs). Also, the user can transmit a comment on the message represented by this message information as appropriate.

In the case where the maintenance information received from the dealer 400 is stored in the private information storage area of the message information storage section 614, the message information management server 612 transmits the maintenance information to the portable information terminal 300 as mentioned above. Thus, in the portable information terminal 300, the main control section 305 presents the received maintenance information to the user through use of the touch-panel-type liquid-crystal display 304.

In this case, for example, if the user wants to take his/her vehicle 100 to the dealer 400 for maintenance in accordance with the presented maintenance information, the user can make a reservation for maintenance with the dealer 400 by use of the presented maintenance information. That is, for example, if the user touches “Reserve Maintenance” displayed on the touch-panel-type liquid-crystal display 304 along with the maintenance information, a format for making a reservation for maintenance with the dealer 400 is displayed. If the user enters all the necessary items in accordance with the displayed maintenance reservation format and performs an operation for transmitting them, the maintenance reservation information which represents the entered necessary items is transmitted via the network 500 to the information management center 200. In this case, the account information given to the user is transmitted along with the maintenance reservation information.

In the information management center 200, the vehicle information management server 212 receives via the communication control section 211 and the network 500 the maintenance reservation information and the account information transmitted from the portable information terminal 300, adds the vehicle identifying ID information to these two pieces of information, and transmits (transfers) them to the dealer 400. In the dealer 400, the vehicle management server 412 identifies the vehicle 100 through use of the vehicle identifying ID information transmitted from the vehicle information management server 212, and stores the maintenance reservation information in the event information storage section 414 while relating it to the vehicle identifying ID information. On the other hand, the user information management server 413 identifies the user through use of the account information. Thus, in the dealer 400, the reservation for maintenance that the user wants can be grasped, and the schedule of maintenance of the vehicle 100 can be managed in accordance with this reservation for maintenance.

As can be understood from the above description, according to the above-described first embodiment, the message information generation/acquisition server 216 of the information management center 200 generates and acquires message information on the basis of the vehicle information acquired from the information transmission/reception ECU 110a of the vehicle 100, and the message information management server 613 of the service providing center 600 can provide to the user the message information generated in such a manner. By virtue of this, the message information generation/acquisition server 216 can generate and acquire various pieces of message information expressed in various ways, and the message information management server 613 can provide to the user the various pieces of message information expressed in various ways, thereby allowing the user to be always interested in the message represented by the provided message information. That is, since the user can be provided with messages expressed in various ways, the user can acquire important information transmitted from the vehicle 100 always with interest as compared with the case where the user is provided with businesslike and stereotypical messages.

In addition, the message information generation/acquisition server 216 can personify the vehicle 100, and generates and acquires message information as that from the personified vehicle 100. Accordingly, the user can be provided with messages from the personified vehicle 100. The user can acquire important information transmitted from the vehicle 100 side with more familiarity (in other words, with more interest) as compared with the case where the user is provided with a businesslike and stereotypical messages.

### b. Second Embodiment

In the above-described first embodiment, while the user is moving by use of the vehicle 100, the information transmission/reception ECU 110a transmits vehicle information to the information management center 200, whereby the message information, etc. which are based on (related to) this vehicle information are provided by the service providing center 600. That is, in the above-described first embodiment, although the user directly acquires the vehicle information (e.g., eco-related information, diagnostic information, etc.) from the vehicle 100, the user also acquires, as message information, etc., the same pieces of information via the portable information terminal 300 from the service providing center 600. In this case, in particular, the driver who is also the user is provided with redundant information, and he/she may feel annoyed. To solve this problem, in a second embodiment, the message information, etc. are provided by the service providing center 600 after the user (driver) stops (parks) the vehicle 100. Hereinafter, this second embodiment will be described in detail; however, descriptions of the portions of the second embodiment which are the same as those of the above-described first embodiments are omitted.

Even in this second embodiment, configurations of the vehicle 100, the information management center 200, the portable information terminal 300, the dealer 400, and the service providing center 600, which constitute the information communication system for a vehicle, are the same as those of the above-described first embodiment. However, in this second embodiment, the information transmission/reception ECU 110a of the vehicle 100 receives from another vehicle ECU 110 an Acc_off signal which represents that the user (driver) has changed the operation position of the ignition switch (not shown) from the “accessory-on” operation position to the “accessory-off” operation position.

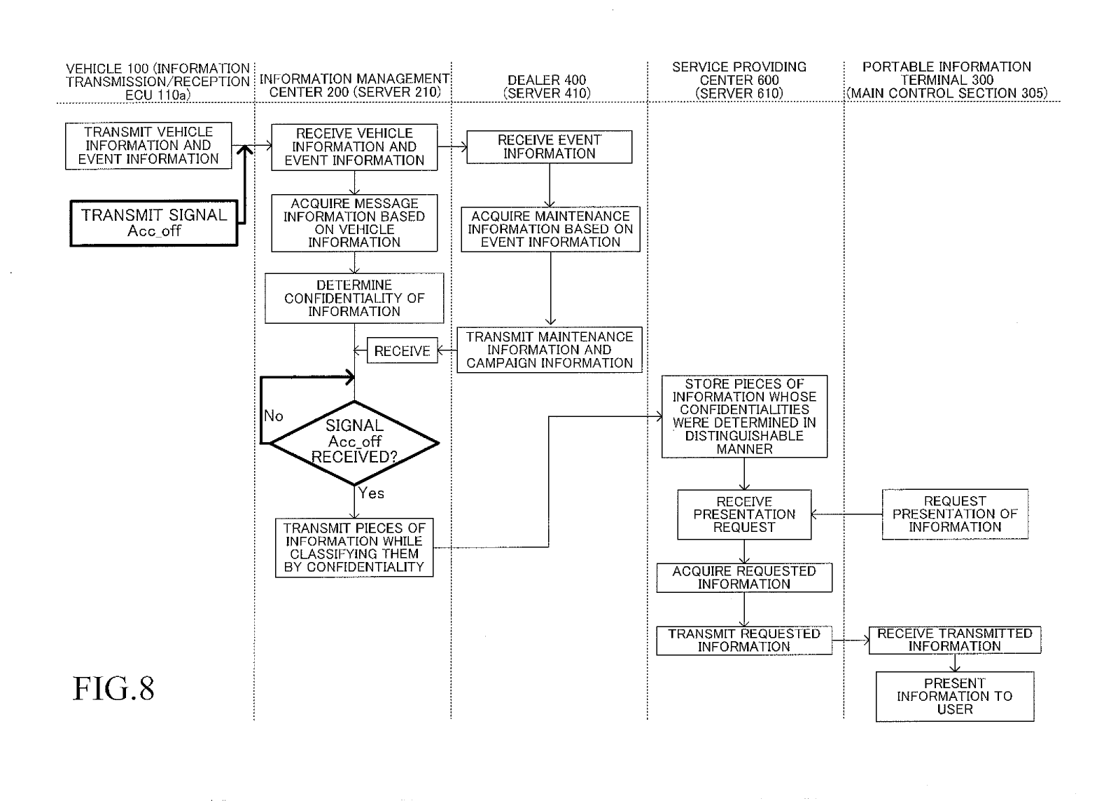

In this second embodiment, just like in the above-described first embodiment, the information transmission/reception ECU 110a of the vehicle 100 transmits the vehicle information, event information, and vehicle identifying ID information which have been acquired from the remaining vehicle ECUs 110. In addition, as indicated by a thick line in FIG. 8, the information transmission/reception ECU 110a of the vehicle 100 transmits the Acc_off signal to the information management center 200 when the user (driver) has changed the operation position of the ignition switch from the “accessory-on” operation position to the “accessory-off” operation position. Namely, when the user (driver) stops (parks) the vehicle 100 and changes the operation position of the ignition switch from the “accessory-on” operation position to the “accessory-off” operation position, the Acc_off signal is transmitted to the information management center 200.

On the other hand, in the information management center 200 to which the Acc_off signal is transmitted, as shown by a thick line in FIG. 8, the server 210 (more specifically, the message information generation/acquisition server 216) determines whether or not the Acc_off signal is received from the vehicle 100. That is, if the message information generation/acquisition server 216 has received, via the network 500 and the external communication control section 211, the Acc_off signal acquired and transmitted by the information transmission/reception ECU 110a of the vehicle 100, the vehicle 100 is stopped (parked) now. Accordingly, the message information generation/acquisition server 216 makes a “Yes” determination. Subsequently, just like in the above-described first embodiment, the message information generation/acquisition server 216 determines whether or not each piece of the acquired message information requires confidentiality, and transmits the message information to the service providing center 600 along with the confidentiality identification information representing the determination result. In addition, just like in the above-described first embodiment, the message information generation/acquisition server 216 transmits to the service providing center 600 the maintenance information and/or campaign information which have been received from the server 410 of the dealer 400.

On the other hand, if the Acc_off signal is not received from the information transmission/reception ECU 110a of the vehicle 100 via the network 500 and the external communication control section 211, the vehicle 100 is not stopped (parked) now; namely, the user (driver) can directly acquire eco-related information, diagnostic information, etc. from, for example, the vehicle 100. Accordingly, the message information generation/acquisition server 216 makes a “No” determination. Subsequently, the message information generation/acquisition server 216 continues to make a “No” determination until the Acc_off signal is received from the information transmission/reception ECU 110a of the vehicle 100. Thus, in a situation in which the vehicle 100 is not stopped (parked), the message information generation/acquisition server 216 does not transmit to the service providing center 600 the message information acquired on the basis of the vehicle information transmitted from the vehicle 100.

Namely, when the Acc_off signal is received from the information transmission/reception ECU 110a of the vehicle 100; in other words, when the vehicle 100 is stopped (parked) by the user (driver), the message information generation/acquisition server 216 transmits to the service providing center 600 the message information, maintenance information, and campaign information to which confidentiality identification information has been added. Accordingly, after stopping (parking) the vehicle 100, by means of accessing the service providing center 600 by use of the portable information terminal 300, the user of the vehicle 100 can be provided with the message information representing a message as if the message is spoken by the personified vehicle 100.

As can be understood from the above description, according to the above-described second embodiment, while the vehicle 100 is travelling, the message information generation/acquisition server 216 of the information management center 200 does not supply message information to the message information management server 613 of the service providing center 600. This operation prevents the message information management server 613 from providing to the portable information terminal 300 the same pieces of message information as those that the user can directly acquire from the vehicle 100. Accordingly, the user of the vehicle 100 does not become indifferent to the information transmitted from the vehicle 100 side, which would otherwise occur when the user acquires the information redundantly. The user of the vehicle can acquire important information transmitted from the vehicle 100 side always with interest.

The present invention is not limited to the above-described embodiments, and various modifications are possible without departing from the scope of the present invention.

For example, in the above-described embodiments, the information communication system is configured such that the vehicle 100 and the information management center 200 are connected via the network 500. Various pieces of information relating to the vehicle 100 are transmitted from the information transmission/reception ECU 110a to the server 210 of the information management center 200. The message information, etc. transmitted from the server 210 are provided to the user via the service providing center 600.

In this case, the above-described embodiments may be modified such that an information terminal apparatus installed in a house having an energy storage function, etc. or an information terminal apparatus installed in a plug-in stand for charging the battery installed in the vehicle 100 may be connected to the information management server 200. Even in this case, just like in the above-described embodiments, the information management center 200 acquires message information on the basis of the vehicle information transmitted from the vehicle 100, and the service providing center 600 provides message information to the user.

In addition, in this case, for example, energy storage information relating to the energy storage of the house may be transmitted from the information terminal apparatus installed in the house in addition to the message information which is based on the vehicle information. In such a case, the information management center 200 acquires energy-related message information which is based on the energy storage information, thereby allowing the service providing center 600 to provide the user with the energy-related message information. Meanwhile, when information such as the charging information relating to the plug-in stand reservation status and the charging price is transmitted from the information terminal apparatus installed in the plug-in stand to the information management center 200, the information management center 200 acquires charging-related message information which is based on this charging information, thereby allowing the service providing center 600 to provide the user with the charging-related message information.

By virtue of this, the user can not only communicate with others regarding the eco-related information of the vehicle 100 but also can communicate with others regarding, for example, the eco-related information of the house. Accordingly, the user can expand the circle of communication so as to widely share the eco-related information with others. In addition, since the user can share charging information, as message information, with others, he/she can acquire information in real time so as to use the plug-in stand efficiently.

Also, in the above-described embodiments, maintenance information and campaign information are transmitted as the information provided by the dealer 400. However, the information provided by the dealer 400 is not limited to the maintenance information and campaign information. It may be, for example, information provided by the staff working in the dealer 400 or information relating to the vehicle 100 which is provided by the car manufacturer. Even in this case, information which is useful to the user can be provided via the service providing center 600.

Also, in the above-described embodiments, the information transmission/reception ECU 110a of the vehicle 100 uses the DCM 150 so as to transmit various pieces of information such as vehicle information and event information to the information management center 200. However, the embodiments may be modified such that the information transmission/reception ECU 110a of the vehicle 100 transmits various pieces of information to the information management center 200 by use of the external communication control section 301 of the portable information terminal 300 paired by the short-range communication control apparatus 160. In this case, the information transmission/reception ECU 110a supplies various pieces of acquired information via the CAN communication line 120 to the short-range communication control apparatus 160. The short-range communication control apparatus 160 supplies the various pieces of supplied information to the paired portable information terminal 300 through short-range radio communication. The portable information terminal 300 transmits the various pieces of supplied information via the external communication control section 301 and relay stations to the information management center 200 connected to the network 500. Accordingly, even in this case, various pieces of information such as vehicle information and event information can be transmitted from the vehicle 100 via the network 500. Therefore, effects similar to those of the above-described embodiments are expected.

Furthermore, in the above-described first embodiment, the service providing center 600 transmits message information, maintenance information, and campaign information via the network 500 to the portable information terminal 300 owned by the user. By virtue of this, the user can receive the information from the service providing center 600 using the portable information terminal 300. However, the embodiment may be modified such that the service providing center 600 transmits message information, maintenance information, and campaign information to the information transmission/reception ECU 110a of the vehicle 100 via the DCM 150, instead of, or in addition to, the portable information terminal 300 owned by the user.

In this case, if the user enters account information by use of, for example, the touch-panel-type liquid-crystal display of the navigation apparatus 170, the information transmission/reception ECU 110a can transmit the account information via the DCM 150 to the service providing center 600. Also, the information transmission/reception ECU 110a can receive message information, maintenance information, and campaign information via the DCM 150 from the service providing center 600. Accordingly, even in this case, just like in the above-described first embodiment, message information, maintenance information, and campaign information can be received from the service providing center 600, whereby the information provided to the user can be presented. Furthermore, for example, an occupant who is riding on the vehicle 100 and who is other than the driver can provide a comment on the message represented by open message information, whereby the circle of communication can be expanded.

1. A vehicle information providing apparatus which is connected to a vehicle via a network and which comprises vehicle information acquisition means for acquiring information which is supplied from the vehicle and which represents a state of the vehicle, and information providing means for providing to contractors of a social networking service, including a user of the vehicle, various pieces of information in accordance with the social networking service, the vehicle information providing apparatus comprising:
user information acquisition means for acquiring user information which is provided in advance so as to receive various pieces of information from the information providing means by identifying the user of the vehicle;
message information generation/acquisition means for generating and acquiring message information, which represents the state of the vehicle and which is provided to at least the user of the vehicle, on the basis of the information which is acquired by the vehicle information acquisition means and which represents the state of the vehicle; and
message information supply means for supplying to the information providing means the message information, which is generated and acquired by the message information generation/acquisition means, on the basis of the user information acquired by the user information acquisition means,
wherein the information providing means opens and provides the message information, supplied from the message information supply means, to the user and the contractors of the social networking service other than the user, in accordance with the social networking service, and provides message information of an account which the contractors follow to the user and the contractors other than the user.

2. A vehicle information providing apparatus according to claim 1, wherein the vehicle is personified, and the message information generation/acquisition means generates and acquires the message information, as a message from the personified vehicle, on the basis of the information which is acquired by the vehicle information acquisition means and which represents the state of the vehicle.

3. A vehicle information providing apparatus according to claim 1, wherein
the message information generation/acquisition means classifies a plurality of pieces of the generated and acquired message information into those which require confidentiality and which should be provided only to the user and those which do not require confidentiality and which can also be provided to third parties other than the user;
the message information supply means supplies the plurality of pieces of the message information to the information providing means in accordance with the classification determined by the message information generation/acquisition means; and
the information providing means provides the plurality of pieces of the message information, which are supplied from the message information supply means, in accordance with the classification determined by the message information generation/acquisition means.

4. A vehicle information providing apparatus according to claim 3, wherein the information providing means provides to an external information providing apparatus a piece of the message information which is classified by the message information generation/acquisition means as that which does not require confidentiality and which can also be provided to third parties other than the user, the piece of the message information being among the plurality of pieces of the message information supplied from the message information supply means.

5. A vehicle information providing apparatus according to claim 4, wherein the external information providing apparatus provides through a social networking service the message information provided by the information providing means.

6. A vehicle information providing apparatus according to claim 1, wherein the user supplies the user information to the information providing means by use of a portable information terminal apparatus owned by him/her, and acquires the message information from the information providing means by use of the portable information terminal apparatus.

7. A vehicle information providing apparatus according to claim 1, further comprising:
vehicle stoppage state determination means for determining whether or not the vehicle is in a stopped state, wherein
the message information supply means supplies the message information to the information providing means when the vehicle stoppage state determination means determines that the vehicle is in the stopped state; and
the message information supply means does not supply the message information to the information providing means when the vehicle stoppage state determination means determines that the vehicle is not in the stopped state.

8. A vehicle information providing apparatus according to claim 7, wherein the vehicle stoppage state determination means determines whether or not the vehicle is in the stopped state in accordance with the operation state of an ignition switch of the vehicle.

9. A vehicle information providing apparatus according to claim 8, wherein the vehicle stoppage state determination means determines that the vehicle is in the stopped state when the operation position of the ignition switch of the vehicle is changed from an accessory-on operation position to an accessory-off operation position.

10. A vehicle information providing apparatus according to claim 1, further comprising:
message information storage means for storing various text data, wherein
the message information generation/acquisition means generates and acquires message information, which represents the information of the vehicle and which is provided to at least the user of the vehicle, by creating a message having an image corresponding to the state of the vehicle on the basis of the information which is acquired by the vehicle information acquisition means and which represents the state of the vehicle, and properly selecting, from the message information storage means, text data suitable for phrases of the created message; and
when the user requests provision of the message information, the information providing means opens and provides the message information, supplied from the message information supply means, to the user and the contractors of the social networking service other than the user, in accordance with the social networking service, and provides message information of an account which the contractors follow to the user of the vehicle and the contractors other than the user.

11. A vehicle information providing apparatus according to claim 1, wherein the information providing means provides the message information, supplied from the message information supply means, to the user of the vehicle and the contractors other than the user such that message information which requires confidentiality and which is to be provided only to the user of the vehicle is provided only to the user of the vehicle who has the user information acquired by the user information acquisition means, in accordance with the social networking service, and message information which does not require confidentiality and which is to be provided also to the contractors other than the user of the vehicle is provided to an external information providing apparatus which provides a social networking service different from the social networking service.
